(19) United States
(12) Patent Application Publication
(10) Pub. No.: US 2005/0044509 A1
(43) Pub. Date: Feb. 24, 2005

(54) Item selection using helical menus

(76) Inventors: Frank A. Hunleth, Rockville, MD (US); William J. Napier, Germantown, MD (US); Daniel S. Simpkins, Bethesda, MD (US)

Correspondence Address: Steven M. duBois;Potomac Patent Group, PLLC, PO Box 855, McLean, VA, 22101-0855, US

(21) Appl. No.: 10/840,001

(22) Filed: May 6, 2004

Related U.S. Application Data
(60) Provisional application No. 60/468,672, filed on May 7, 2003.

(51) Int. Cl. G09G 5/00

(52) U.S. Cl. 715/834; 715/841; 715/810; 715/835; 715/836; 715/837; 715/838; 715/840; 715/846

(57) ABSTRACT

Systems and methods according to the present invention address these needs and others by providing techniques for selecting items from a list that can be operated using, for example, a pointing device or a wheel device. According to exemplary embodiments of the present invention, items are arranged in a list as regions along a three dimensional helical surface. For example, each item can be allocated to a wedge-shaped region along the helical surface. The user can select items by, for example, using a pointing device to pick that item's wedge or by using a wheel device to sequence through the items on the helical surface. Alternatively, a combination of a wheel and pointing device can be used to first scroll the helical surface, and then select an individual item. A clipping plane is used to remove parts of the helical surface from view once the user scrolls past them and reveal the selections in the cycle of the helical surface immediately beneath the clipping plane. Another feature of the helical surface menu is that it can be turned on its side and navigated at a coarse granularity.

### RELATED APPLICATIONS

This application is related to, and claims priority from, U.S. Provisional Patent Application Ser. No. 60/468,672 filed on May 7, 2003, entitled “Item Selection Using Helical Menus”.

### BACKGROUND

The present invention describes systems and methods for item selection, e.g., in a user interface, which employ one or more helical item selection objects.

Technologies associated with the communication of information have evolved rapidly over the last several decades. Computers, television, cellular telephony, the Internet and optical communication techniques combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds and potentially thousands of channels of shows and information. Video-on-demand technology, currently used primarily in hotels and the like, provides the potential for in-home entertainment selection from among thousands of movie titles. Similarly, personal computers have evolved from machines that were loaded with a handful of programs which were individually run in isolation to systems that concurrently run a number of programs each of which may have a large number of options and features from which a user can select.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider the example of computer systems. Various graphical user interfaces have been developed over the years which enable users to select one of a number of options, e.g., programs to run, program features to enable, etc. These interfaces have used different mechanisms for providing users with the capability to make these selections. One such mechanism, shown in FIGS. 1(a) and 1(b) is the linear list. Therein, a linear list of items is displayed, e.g., on the computer's display screen, in either a vertical (FIG. 1(a) or horizontal (FIG. 1(b)) orientation. Multiple linear lists can be employed, e.g., as part of a menu in a drop-down fashion. Selections can be performed using a keyboard or a pointing device to move a cursor (not shown) over the desired item and actuating a selection input.

One disadvantage of linear lists is that a user who uses a pointing device, such as a mouse, to make selections may need to move the pointer large distances on the screen to make selections, thus lowering the efficiency of the interface. This limitation is addressed in radial (pie) menus, an example of which is provided in FIG. 2. Pie menus layout items around the circumference of a circle so that the user only needs to point in the direction of the item to select a desired item. Pie menus are efficient in terms of pointing but can only support a limited number of selectable items before the items are packed too closely together to be legible.

A third type of selection mechanism is referred to as a marking menu. Unlike linear lists and pie menus, a user makes a selection in a marking menu based on a direction of motion of a cursor as opposed to its location on the display. Thus, referring to the example of FIG. 3, a selection of Menu Item 1 can be made by making a stroke 10 in the direction of that menu item using, e.g., a light pen on a touch screen. Variations on these selection mechanisms have also been proposed. For example, U.S. Pat. No. 5,962,178 describes a selection mechanism which has both linear and radial portions. Nonetheless, other mechanisms for selecting items which are easy to use and enable users to rapidly select from among large (or small) numbers of items are needed.

### SUMMARY

Systems and methods according to the present invention address these needs and others by providing techniques for selecting items from a list that can be operated using, for example, a pointing device or a wheel device. According to exemplary embodiments of the present invention, items are arranged in a list as regions along a three dimensional helical surface. For example, each item can be allocated to a wedge-shaped region along the helical surface. The user can select items by, for example, using a pointing device to pick that item's wedge or by using a wheel device to sequence through the items on the helical surface. Alternatively, a combination of a wheel and pointing device can be used to first scroll the helical surface, and then select an individual item. A clipping plane is used to remove parts of the helical surface from view once the user scrolls past them and reveal the selections in the cycle of the helical surface immediately beneath the clipping plane. Another feature of the helical menu is that it can be turned on its side and navigated at a coarse granularity.

According to one exemplary embodiment of the present invention, a method for item selection includes the steps of displaying a helical surface having an axis, providing a plurality of items on the helical surface and selecting one of the plurality of items.

According to another exemplary embodiment of the present invention, a user interface includes a helical surface having an axis, a plurality of items displayed on said helical surface; and

means for selecting one of said plurality of items.

### BRIEF DESCRIPTION OF THE DRAWINGS

The accompanying drawings illustrate exemplary embodiments of the present invention, wherein:

FIGS. 1(a) and 1(b) depict conventional linear lists;

FIG. 2 depicts a conventional pie menu;

FIG. 3 depicts a conventional marking menu;

FIG. 4 shows an exemplary computer system in which the present invention can be implemented;

FIGS. 5(a) and 5(b) depict a helical menu according to an exemplary embodiment of the present invention;

FIG. 6 illustrates a helical menu relative to a display screen according to an exemplary embodiment of the present invention; and

FIG. 7 shows a helical menu displayed in a different orientation relative to a display screen according to an exemplary embodiment of the present invention.

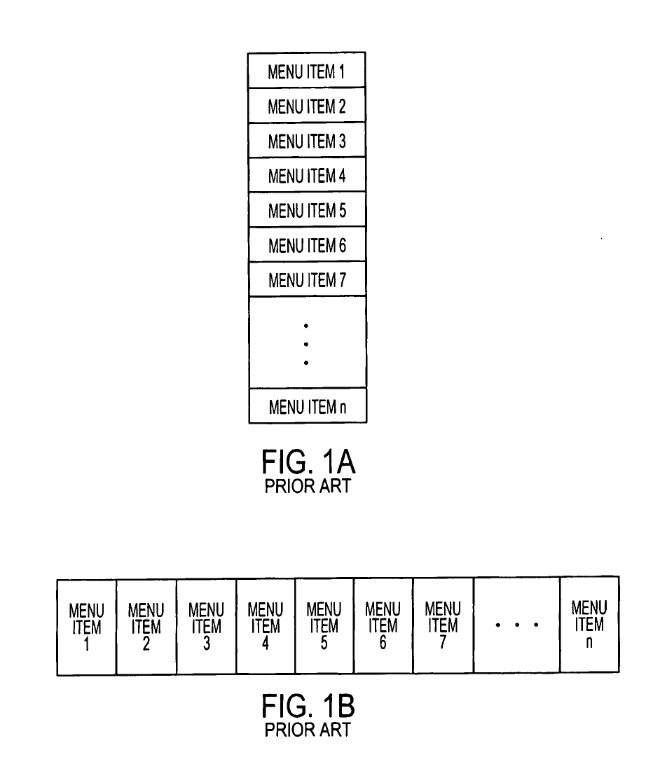

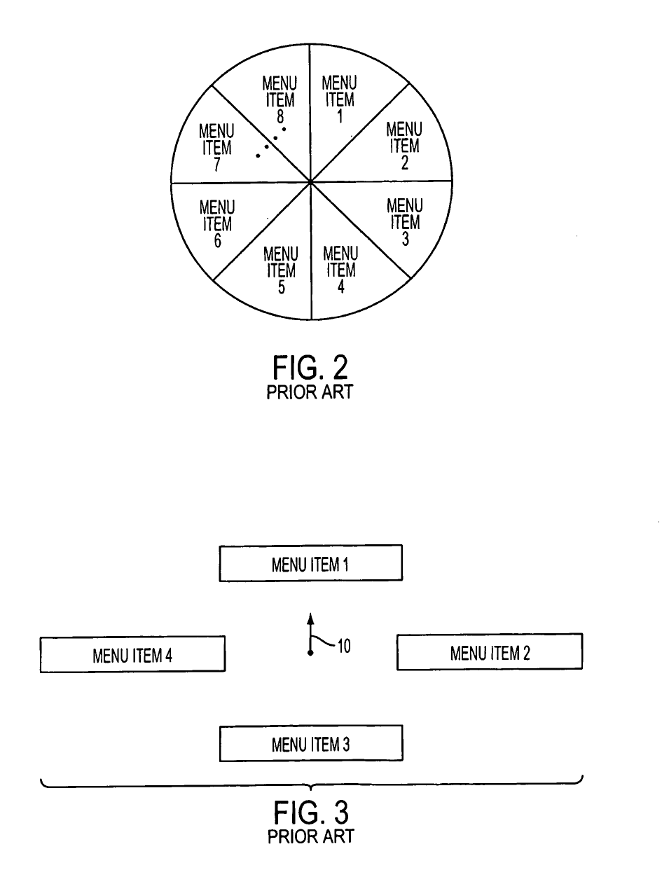

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

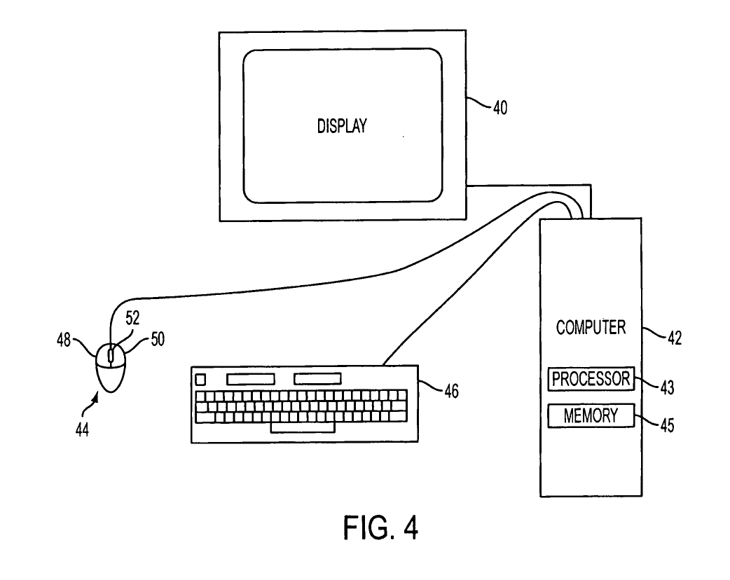

In order to provide some context for this discussion, an exemplary computer system in which the present invention can be implemented will first be described with respect to FIG. 4. Those skilled in the art will appreciate, however, that the present invention is not restricted to implementation in this type of system and that it can be implemented in any system or device which employs a user interface. Therein, a display 40 is connected to a computer 42. The computer 42 includes, among other things, at least one main processor 43, memory 45 and other hardware/software used to generate interfaces according to exemplary embodiments of the present invention. Input devices including a pointing device 44 and keyboard 46 can be used to interact with the interfaces generated by computer 42 and shown on display 40. In this example, the pointing device 44 is a mouse having two buttons 48, 50 and a scroll wheel 52, however those skilled in the art will appreciate that any type of pointing device can be used in conjunction with the present invention, including a pen, a trackball or a joystick. Likewise display 40 can be any type of display capable of generating showing interfaces according to the present invention including a CRT, liquid crystal display or touch-sensitive display (in which case the pointing device 44 can be omitted). Computer 42 can be a personal computer, a workstation or a mainframe.

Generation and control of a user interface according to exemplary embodiments of the present invention is performed, generally, by the processor 43 executing sequences of instructions contained in the memory 45. Such instructions may be read into the memory 45 from other computer-readable mediums such as data storage device(s) or via an external source, e.g., the Internet. Execution of the sequences of instructions contained in the memory 45 causes the processor 43 to generate user interface objects and controls, among other things, on display 40. In alternative embodiments, hard-wire circuitry may be used in place of or in combination with software instructions to implement the present invention. For example, helical menus according to exemplary embodiments of the present invention can be (at least partially) accelerated on a graphics card.

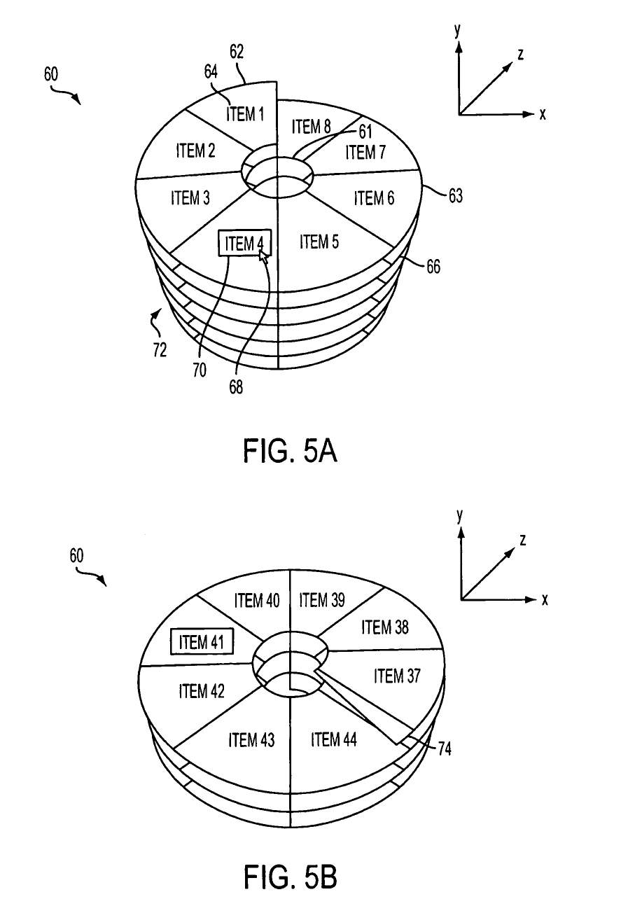

Having described an exemplary computer system which can be used to implement user interfaces and selection mechanisms, several examples of such interfaces according to the present invention will now be described. FIG. 5(a) shows a first view of a helical menu 60 according to an exemplary embodiment of the present invention wherein eight menu items are fully exposed for selection. Generally speaking, a helix is a curve that lies on the surface of a cylinder or cone and cuts the cylinder or cone at an angle, referred to herein as the “helical angle”. However, according to the present specification, the terms “helix” and “helical” are not so limited, but also include curves which lie on surfaces other than cylinders or cones, e.g., square, rectangular or other solids. Helical menus according to exemplary embodiments of the present invention can then be formed by displaying a helical surface as an inner helix 61 connected to an outer helix 63 with a surface therebetween. Since the outer helix 63 is longer than the inner helix 61, it will typically have a smaller helical angle than the inner helix 61. The helical angles can be constant for both the inner helix 61 and the outer helix 63 or one or both of the helical angles may vary. For example, if the helical menu 60 does not have many selection items contained therein, it may be desirable to increase the helical angle along the length of the helical menu 60 in order to stretch the helical menu out along the display.

The helical menu 60 can, for example, be displayed as superimposed on top of a background 72 of the display 40 in a manner similar to that of a popup menu. The surface between the inner helix 61 and the outer helix 63 of the helical menu 60 is divided into wedges 62 that contain, for example, some combination of text and/or icons 64 that describe the items which can be selected. The wedges 62 can be opaque or can by at least partially translucent or transparent in order to provide a user with another indication that there are additional selection items available by navigating along the helical surface. Note that in this example, the helical menu 60 has been tilted outwardly toward the user (i.e., in the -z axis direction of the display 40, such that the axis of the helical surface is offset from the perpendicular to a plane associated with the display screen) to show the user that more than eight items are available lower in the helical surface. This can be accomplished by rotating the helical menu by a predetermined tilt angle around the x-axis. The tilt angle can be, for example, within the range of 30-60 degrees and specifically 45 degrees, although tilt angles outside of this range may be used as well. Thus, some wedges 66 are partially hidden below the current, fully exposed, layer. For the purposes of this description, the term “cycle” is used to refer to the section of the helical surface which is fully exposed at a given time, which, in the case of FIG. 5(a) includes the wedges 62 which contain items 1-8. If the user moves a pointer 68 over a wedge 62, the wedge 62 or its text can be highlighted using, e.g., a bounding box 70, and the item represented by that wedge is considered selected. Once an item is selected, a semantic change associated with that selection may be displayed. For example, if the item is “channel 25”, then details of programming associated with channel 25 can be displayed either on the selected wedge itself or elsewhere on the display screen. If the pointing device 44 includes a scroll wheel 52, then the wheel can optionally be used to move a cursor that represents the currently selected wedge up and down the helical menu 60.

FIG. 5(b) shows the same helical menu as FIG. 5(a) at a point wherein the user has scrolled more deeply into the selection items, i.e., now menu items 37-44 are visible instead of menu items 1-8. This view shows the effect of a clipping function which prevents items that are above the clipping plane from being shown. Thus, in this example, items 1-36 are no longer displayed, since they are above the clipping plane. Items 37-44 are part of the currently displayed cycle and some of the items 45+ are, optionally, indicated by partially exposed wedges further down the helical menu 60. Note that the edge 74 is the location where the invisible clipping plane intersects the helical menu 60.

FIG. 6 shows a rotated view of the helical menu 60 which depicts an exemplary relationship between the clipping plane 76 and the helical menu 60. An axis 78 of the helical menu 60 is normal to the clipping plane 76. Furthermore, note that the clipping plane 76 does not need to be parallel with the plane of the display screen 80 if, for example, it is desirable to display portions of wedges beneath the currently exposed cycle as described above. This view also shows an exemplary tilt angle Φ for the helical surface 60 relative to the display screen 80. Moving the helical surface through the clipping plane 76 as the user navigates along the helical menu 60 can be accomplished in at least two different ways. One way is to display the helical surface translating along its axis 78 up and down through the clipping plane 76. Another way is to display the helical surface rotating like a screw through the clipping plane 76. Exemplary interaction techniques between a user and exemplary interfaces according to the present invention for navigating along the helical menu 60 are described below.

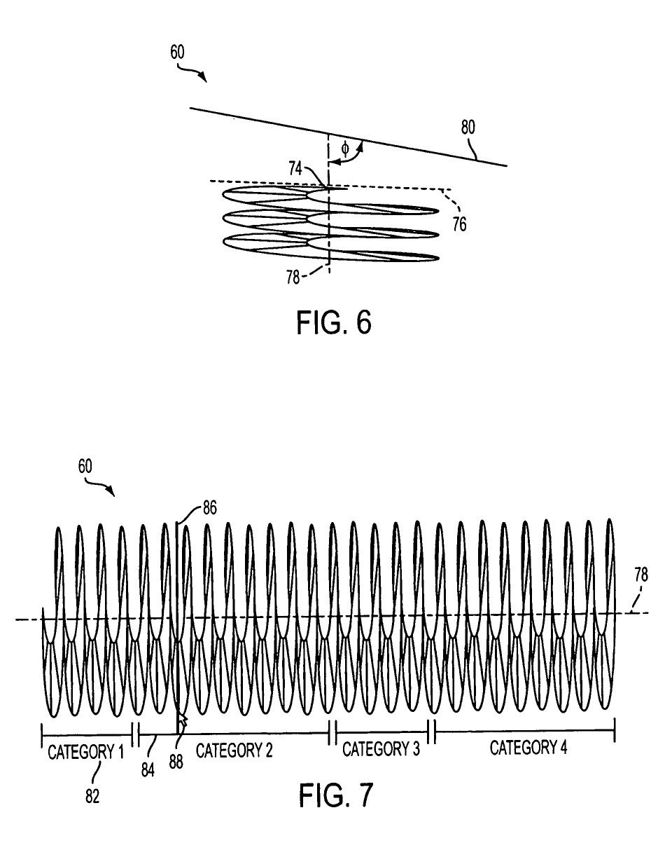

FIG. 7 shows a view of the helical menu 60 from a side angle. The view shown in FIG. 7 can, for example, be used to quickly jump between different portions of the helical menu 60 since more cycles of the helical surface can be displayed using this view than that of FIG. 5(a). Items in the list can be categorized into groups 82 and range bars 84 can be used to show where items in a group appear in the helical menu 60. A marking plane 86 can be provided which slices through the helical menu 60 at the cursor's current location in the menu. The user can, for example, use a cursor 88 to move the marking plane 86 back and forth along the helical menu 60 or alternatively the scroll wheel 52 could move the marking plane 86. Like the foregoing exemplary embodiment of FIGS. 5(a) and 5(b), the helical menu 60 of FIG. 7 can be clipped on both the left and right sides if a sufficiently large number of selection items and/or categories are provided. Using both the views of FIGS. 5 and 7, an interface can be created which allows a user to scroll rapidly through a large number of items and then select a specific item. Consider the example wherein each wedge portion 62 of the helical surface contains a media item, e.g., a movie selection item or a television channel, which can be selected. A user may start with the side view exemplified by FIG. 7 to quickly reach a category of interest, e.g., Action Movies. The user can then actuate a control element (not shown), e.g., a button displayed on the interface, which instructs the processor 43 to change to the view exemplified by FIG. 5(a) with the currently displayed cycle being that which was indicated by the user based on the position of the marking plane 86 at the time that the view was changed. A transition effect can be provided when switching between different views of the helical menu. For example, when transitioning between the view of, e.g., FIG. 5(a) and the view of, e.g., FIG. 7, an animation effect can be provided for the transition wherein the helical menu 60 smoothly rotates and falls on its side.

There are many different ways in which users can interact with helical menus 60 according to exemplary embodiments of the present invention. A few examples will now be described, however those skilled in the art will appreciate that many other interactions can be implemented depending upon the desired application for the present invention. For example, if a mouse or other type of pointing device 44 having at least two buttons is used, the user can point to any of the currently displayed wedges 62 by moving a cursor 68 over the desired wedge 62. By pressing one of the buttons 48 or 50 on the pointing device 44, the user selects the item in that wedge 62. The user can navigate to other layers in the helical menu 60 by, for example, holding down a second button 50 or 48 on the pointing device and performing a drag operation in one axial direction or the other, e.g., dragging up or down the helical surface. Alternatively, a conventional, e.g., television, remote control device (not shown) can be used in conjunction with helical menu such that, for example, up or down arrow buttons can be used to navigate through the helical menu to select a television channel or program.

For interfaces employing a three button pointing device (not shown), one button can be used for item selection, one button for navigating in one direction along the helical menu 60 and the other button for navigating in the other direction along the helical menu 60. To show the side view of the helical surface (e.g., FIG. 7), the user can, for example, hold down one of the pointing device's buttons and drag the helical menu 60 to the side. Once in the side view, the marking plane 86 follows the cursor 88 as the user selects an area of the helical menu 60. When the user presses one of the buttons of the pointing device, the helical surface rotates back to the view shown in FIGS. 5(a) and 5(b) with the cursor 68 pointing to one of the items in the cycle pointed to by marking plane 86, e.g., the uppermost item in that cycle.

Other exemplary interaction methods for helical menus 60 according to the present invention employ the wheel device 52. For example, in FIG. 5(a), the cursor 68 may have a starting position at “Item 4”. The interface highlights this item by, for example, drawing a bounding box 70 around the item displayed within the corresponding wedge 62 or using another graphical method of drawing attention to a currently selected item. When the user rolls the wheel in one direction, the cursor moves up the helical menu 60 causing helical surface to move down and reveal items which were previously clipped by clipping plan 76. Alternatively, rolling the wheel in the other direction causes the cursor to move down the helical menu 60, and hence moves the helical surface up towards the user through the clipping plane 76, revealing items contained in wedges further down the helical surface. Pressing a first button on the pointing device 44 selects the current item. Pressing a second button causes the helical surface to rotate to the side as in FIG. 7. In this view, rolling the wheel moves the pointer 86 back and forth. Pressing the first button again causes the helical surface to rotate back to the view shown, e.g., in FIGS. 5(a) and 5(b).

Those skilled in the art will appreciate that the helical menus and helically-shaped user interface objects according to the present invention can be used in a number of different computer application. However the present invention is not limited to application in computer interfaces and can also be used in, e.g., personal digital assistants, cellular telephones, interactive television and any other devices and systems which employ display screens. With respect to applications involving interactive television and the like, examples of such interfaces are described in co-pending, commonly assigned U.S. patent application Ser. No. 10/768,422, entitled “Systems and Methods for Resolution Consistent Zooming”, filed on Jan. 30, 2004, the disclosure of which is incorporated here by reference. Employing one or more helical menus in systems such as those described in the above-incorporated patent application may result in, for example, systems in which the helical menu 60 provides for TV channels and/or movies (e.g., thumbnail representations) to be depicted in the wedges 62 of the helical surface. Another exemplary application for helical menus according to the present invention is for use in an interface which aids a user in selecting musical albums or songs, selecting radio stations, or address book entries.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing exemplary embodiments of the present invention describe helical menus having axes which are straight lines, the present invention is not so limited. The helical menu axis could, for example, be circular to provide a wrap-around effect between the ends of the helical menu. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for item selection comprising the steps of:
displaying a helical surface having an axis;
providing a plurality of items on said helical surface; and
selecting one of said plurality of items and
clipping from view items on said helical surface which are above said clipping plane.

2. The method of claim 1, wherein said plurality of items includes at least one of: media items, software applications and features associated with a software application.

3. The method of claim 1, wherein said step of displaying a helical surface further comprises the step of:
displaying said helical surface with said axis oriented substantially perpendicular to a plane associated with a display screen.

4. The method of claim 3, further comprising the step of:
tilting said axis of said helical surface by a predetermined tilt angle relative to perpendicular to said plane associated with said display screen.

5. The method of claim 4, wherein said predetermined tilt angle is within the range of 30-60 degrees.

6. The method of claim 1, wherein said step of providing a plurality of items on said helical surface further comprises the step of:
allocating a portion of said helical surface to each of said plurality of items.

7. The method of claim 6, wherein said portion is wedge-shaped.

8. (Canceled)

9. The method of claim 1, wherein said step of displaying further comprises the step of:
displaying said helical surface with said axis oriented substantially parallel to a plane associated with a display screen.

10. The method of claim 9, further comprising the step of:
displaying a plurality of category labels along said helical surface which identify groups of said plurality of items.

11. The method of claim 3, further comprising the step of:
changing a view of said helical surface such that it is displayed with said axis oriented substantially parallel to said plane associated with said display screen.

12. The method of claim 1, further comprising the step of:
scrolling through said plurality of items using a pointing device.

13. A user interface comprising:
a helical surface having an axis;
a plurality of items displayed on said helical surface;
means for selecting one of said plurality of items; and
a clipping plane for clipping from view items on said helical surface which are above said clipping plane.

14. The user interface of claim 13, wherein said plurality of items includes at least one of: media items, software applications and features associated with a software application.

15. The user interface of claim 13, wherein said axis is oriented substantially perpendicular to a plane associated with a display screen.

16. The user interface of claim 15, wherein said axis of is tilted by a predetermined tilt angle relative to perpendicular to said plane associated with said display screen.

17. The user interface of claim 16, wherein said predetermined tilt angle is within the range of 30-60 degrees.

18. The user interface of claim 13, wherein each of said plurality of items displayed on said helical surface is allocated to a predetermined portion thereof.

19. The user interface of claim 18, wherein said portion is wedge-shaped.

20. (Canceled)

21. The user interface of claim 13, wherein said axis is oriented substantially parallel to a plane associated with a display screen.

22. The user interface of claim 21, further comprising a plurality of category labels along said helical surface which identify groups of said plurality of items.

23. The user interface of claim 15, further comprising:
means for changing a view of said helical surface such that it is displayed with said axis oriented substantially parallel to said plane associated with said display screen.

24. The user interface of claim 13, further comprising:
means for scrolling through said plurality of items using a pointing device.

25. The method of claim 1, wherein said helical surface comprises an outer helix, an inner helix and a surface therebetween.

26. The method of claim 25, wherein said outer helix has a first helical angle associated therewith and said inner helix has a second helical angle associated therewith, said first helical angle being different from said second helical angle.

27. The method of claim 25, wherein said surface is at least partially translucent or transparent.

28. The method of claim 1, wherein said axis is linear.

29. The method of claim 11, further comprising the step of:
animating a transition between said step of displaying said helical surface with said axis oriented substantially perpendicular to said plane associated with said display screen and said step of changing said view of said helical surface such that it is displayed with said axis oriented substantially parallel to said plane associated with said display screen.

30. The method of claim 25, wherein said outer helix and said inner helix have at least one helical angle associated there with which varies as a function of length of said helical surface.

31. The user interface of claim 13, wherein said helical surface comprises an outer helix, an inner helix and a surface therebetween.

32. The user interface of claim 31, wherein said outer helix has a first helical angle associated therewith and said inner helix has a second helical angle associated therewith, said first helical angle being different from said second helical angle.

33. The user interface of claim 31, wherein said surface is at least partially translucent or transparent.

34. The user interface of claim 13, wherein said axis is linear.

35. The user interface of claim 23, further comprising the step of:
animating a transition between said step of displaying said helical surface with said axis oriented substantially perpendicular to said plane associated with said display screen and said step of changing said view of said helical surface such that it is displayed with said axis oriented substantially parallel to said plane associated with said display screen.

36. The user interface of claim 31, wherein said outer helix and said inner helix have at least one helical angle associated there with which varies as a function of length of said helical surface.

37. A computer-readable medium containing a program that performs the steps of:
displaying a helical surface having an axis;
providing a plurality of items on said helical surface;
selecting one of said plurality of items; and
clipping from view items on said helical surface which are above said clipping plane.

38. A method for item selection comprising the steps of:
displaying a helical surface having an axis;
providing a plurality of items on said helical surface;
selecting one of said plurality of items; and
wherein said axis is substantially parallel to a plane associated with a screen on which said helical surface is displayed

39. A user interface comprising:
a helical surface having an axis;
a plurality of items displayed on said helical surface;
means for selecting one of said plurality of items; and
wherein said axis is substantially parallel to a plane associated with a screen on which said helical surface is displayed.
